(19) United States
(12) Patent Application Publication
(10) Pub. No.: US 2025/0349889 A1
(43) Pub. Date: Nov. 13, 2025

(54) GEL POLYMER ELECTROLYTE BASED ON POLY(4-HYDROXYBUTYL ACRYLATE) OR POLY(4-HYDROXYBUTYL METHACRYLATE) AND METHOD FOR PREPARING THE SAME

(71) Applicant: Kyungpook National University Industry-Academic Cooperation Foundation, Daegu (KR)

(72) Inventors: KYEONGWOON CHUNG, Daegu (KR); Hui Ju CHOI, Daegu (KR)

(73) Assignee: Kyungpook National University Industry-Academic Cooperation Foundation, Daegu (KR)

(21) Appl. No.: 19/204,220

(22) Filed: May 9, 2025

(30) Foreign Application Priority Data
May 10, 2024 (KR) 10-2024-0062110

(51) Int. Cl. H01M 10/0565

(52) U.S. Cl. CPC H01M 10/0565; H01M 2300/0082; H01M 2300/0085

(57) ABSTRACT

A gel polymer electrolyte provided, including: a polymer formed by polymerizing a monomer of 4-hydroxybutyl acrylate (HBA) represented by the following Chemical Formula 1 or a monomer of 4-hydroxybutyl methacrylate (HBMA) represented by the following Chemical Formula 2; and a crosslinking agent, and a method for preparing the same.

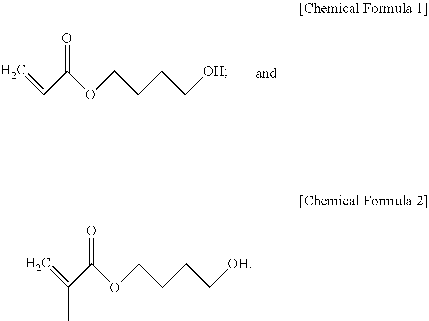

### CROSS REFERENCE TO RELATED APPLICATION

The present application claims priority to Korean Patent Application No. 10-2024-0062110, filed May 10, 2024, the entire contents of which are hereby incorporated by this reference.

### STATEMENT REGARDING PRIOR DISCLOSURES BY THE INVENTOR OR A JOINT INVENTOR

Prior disclosure related to the present application was made by inventors of the present application in journal paper entitled “Gel polymer electrolyte with improved adhesion property based on poly(4-hydroxybutyl acrylate) for lithium-ion batteries” published in 2023. A copy of the journal paper is provided on an Information Disclosure Statement filed concurrently.

### BACKGROUND

### Field

The present invention relates to a gel polymer electrolyte based on poly(4-hydroxybutyl acrylate) or poly(4-hydroxybutyl methacrylate) having excellent adhesion characteristics, and a method for preparing the same.

### Description of the Related Art

Lithium ion batteries have been widely utilized in various application fields based on their characteristics such as high energy density and long service life. Lithium ion batteries are used as existing power source devices for various electronic products, such as mobile phones and laptops, and in the field of new and renewable energy, lithium ion batteries have been utilized as storage devices for energy produced by solar cells or wind turbines. Further, the lithium ion battery is a core component of an electric vehicle. However, lithium ion batteries still have a weak point of safety issues.

In lithium ion batteries, liquid electrolytes are usually used, and have a possibility of showing problems such as flammability, corrosion, leakage, thermal instability, and high-voltage instability, which may lead to fires or explosions during abnormal battery operation.

To solve these problems, studies on solid electrolytes have been ongoing, and particularly, gel polymer electrolytes have been drawing attention as an alternative. However, since most gel polymer electrolytes are manufactured outside a lithium ion battery and then inserted between a positive electrode and a negative electrode in many cases, the gel polymer electrolytes have a problem in that the contact area between the electrodes and the electrolyte may be remarkably decreased compared to liquid electrolytes. Furthermore, gel polymer electrolytes have lower electrochemical stability and ionic conductivity than liquid electrolytes in many cases. In addition, at a current time when the importance of various flexible batteries is emerging, it is emerging as an important issue to secure excellent adhesion between the electrodes and electrolyte.

Therefore, there is growing interest in gel polymer electrolytes having excellent adhesion, electrochemical stability, and high ionic conductivity.

### RELATED ART DOCUMENTS

### Patent Documents

(Patent Document 1) U.S. Pat. No. 11,830,975 (Nov. 28, 2023)

### SUMMARY

To solve the aforementioned problems, an object of the present invention is to provide a gel polymer electrolyte based on poly(4-hydroxybutyl acrylate) or poly(4-hydroxybutyl methacrylate), in which compositions are mixed in a ratio that enables gelation, and a method for preparing the same.

Further, to solve the aforementioned problems, an object of the present invention is to provide a gel polymer electrolyte based on poly(4-hydroxybutyl acrylate) or poly(4-hydroxybutyl methacrylate) having excellent adhesion, and a method for preparing the same. In addition, to solve the aforementioned problems, an object of the present invention is to provide a gel polymer electrolyte based on poly(4-hydroxybutyl acrylate) or poly(4-hydroxybutyl methacrylate) having high electrochemical stability, and a method for preparing the same.

Furthermore, to solve the aforementioned problems, an object of the present invention is to provide a gel polymer electrolyte based on poly(4-hydroxybutyl acrylate) or poly(4-hydroxybutyl methacrylate) having high ionic conductivity, and a method for preparing the same.

To achieve the objects of the present invention as described above, the present invention discloses a gel polymer electrolyte including: a polymer formed by polymerizing a monomer of 4-hydroxybutyl acrylate (HBA) represented by the following Chemical Formula 1 or a monomer of 4-hydroxybutyl methacrylate (HBMA) represented by the following Chemical Formula 2; and a crosslinking agent.

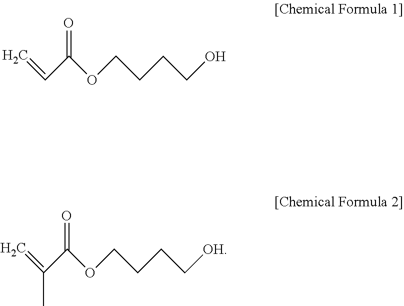

The relative volume ratio of the monomer to the crosslinking agent is 1:99 to 99:1.

Alternatively, the relative volume ratio of the monomer to the crosslinking agent is 65:35 to 99:1.

The crosslinking agent is composed of an acrylate-based or methacrylate-based material.

The crosslinking agent includes at least one selected from the group consisting of poly(ethylene glycol) diacrylate (PEGDA), 1,6-hexanediol diacrylate (HDDA), dipropylene glycol diacrylate (DPGDA), neopentyl glycol diacrylate (NPGDA), 1,2-propanediol diacrylate (PDDA), 1,3-butylene glycol diacrylate (BGDA), 1,4-butanediol diacrylate (BDDA), triethylene glycol diacrylate (TEGDA), tetraethylene glycol diacrylate (TetEGDA), pentaerythritol triacrylate (PETA), trimethylolpropane triacrylate (TMPTA), ethoxylated trimethylolpropane triacrylate (TMP3EOTA), trimethylolpropane trimethacrylate (TMPTMA), pentaerythritol tetraacrylate (PET4A), dipentaerythritol hexaacrylate (DPHA), vinyltriethoxysilane (CH₂=CHSi(OCH₂CH₃)₃), vinyltrimethoxysilane (CH₂=CHSi(OCH₃)₃), vinyl-tris-(2-methoxyethoxy) silane (CH₂=CHSi(OCH₂CH₂OCH₃)₃), vinylmethyldimethoxysilane (CH₂=CHSiCH₃(OCH₃)₂), butyl melamine-based, isocyanate-based, metal chelate-based, and epoxy-based crosslinking agents.

The gel polymer electrolyte further includes an electrolyte solution containing a salt.

The salt includes at least one selected from the group consisting of LiPF₆, LiBF₄, LiClO₄, LiAsF₆, LiSbF₆, LiPF₃ (CF₂CF₃)₃, LiN(SO₂CF₃)₂, LiN (C₂F₅SO₂)₂, LiC(CF₃SO₂)₃, LiCF₃SO₃, LiC₄F₉SO₃, Li(CF₃SO₂)₂N, LiB(C₂O₄)₂ (LiBOB), LiC₂F₆NO₄S₂ (LiTFSI), LiPO₂F₂, lithium difluorobisoxalato phosphate (LiDFOP), and lithium difluoro (oxalato) borate (LiDFOB), and the electrolyte solution includes at least one selected from the group consisting of carbonate-based electrolytes including ethylene carbonate (EC), dimethyl carbonate (DMC), propylene carbonate (PC), diethyl carbonate (DEC), fluoroethylene carbonate (FEC), ethylmethyl carbonate (EMC), methylpropyl carbonate (MPC), ethylpropyl carbonate (EPC), butylene carbonate (BC), and the like.

The gel polymer electrolyte has a tanδ value of 1 or less, and the tanδ is a value defined as G″ (loss modulus)/G′ (storage modulus).

Further, the present invention discloses a method for preparing a gel polymer electrolyte, the method including: adding 4-hydroxybutyl acrylate (HBA) or 4-hydroxybutyl methacrylate (HBMA) as a monomer to an electrolyte solution containing a salt, and adding a crosslinking agent and a polymerization initiator to the electrolyte solution to produce a pre-gel solution; and an in-situ process step of applying the pre-gel solution onto an electrode and then initiating a polymerization reaction.

The polymerization initiator includes a photoinitiator or a thermal initiator, the photoinitiator includes at least one selected from the group consisting of 2-hydroxy-2-methylpropiophenone (HMPP), 1-hydroxycyclohexyl phenyl ketone (HCPK), diphenyl (2,4,6-trimethylbenzoyl) phosphine oxide (TPO), phenylbis(2,4,6-trimethylbenzoyl) phosphine oxide (BAPO) or Type I photoinitiator and Type II photoinitiator, or a compound capable of generating radicals by light, and the thermal initiator includes at least one selected from the group consisting of azobisisobutyronitrile (AIBN), benzoyl peroxide (BPO), or a compound capable of generating radicals by heat.

The effects of the present invention obtained through the above-described means for solution are as follows.

The present invention can provide an appropriate composition ratio of a gel polymer electrolyte composition based on poly(4-hydroxybutyl acrylate) or poly(4-hydroxybutyl methacrylate), in which the tanδ value of the gel polymer electrolyte is 1 or less.

In addition, the gel polymer electrolyte based on poly(4-hydroxybutyl acrylate) or poly(4-hydroxybutyl methacrylate) proposed in the present invention has a higher level of adhesion than gel polymer electrolytes in the related art.

Furthermore, the gel polymer electrolyte based on poly(4-hydroxybutyl acrylate) or poly(4-hydroxybutyl methacrylate) proposed in the present invention can be prepared in-situ on a positive electrode or negative electrode during the manufacture of a lithium ion battery, solving a problem in that gel electrolytes in the related art could not completely fill the spaces between powders that make up the electrodes.

Further, the gel polymer electrolyte based on poly(4-hydroxybutyl acrylate) or poly(4-hydroxybutyl methacrylate) proposed in the present invention has excellent electrochemical stability equivalent to that of liquid electrolytes.

In addition, the gel polymer electrolyte based on poly(4-hydroxybutyl acrylate) or poly(4-hydroxybutyl methacrylate) proposed in the present invention has an ionic conductivity of 10⁻³ S/cm or more.

Since the gel polymer electrolyte based on poly(4-hydroxybutyl acrylate) or poly(4-hydroxybutyl methacrylate) proposed in the present invention has higher flexibility than solid electrolytes, the gel polymer electrolyte can be easily prepared in various shapes, and thus can be utilized in flexible batteries.

### BRIEF DESCRIPTION OF THE DRAWINGS

FIG. 1 is a schematic view of the gel polymer electrolyte based on poly(4-hydroxybutyl acrylate) according to an embodiment of the present invention, and a conceptual view showing a process for preparing the gel polymer electrolyte based on poly(4-hydroxybutyl acrylate).

FIG. 2 is a set of graphs relating to the gelation suitability of the gel polymer electrolyte based on poly(4-hydroxybutyl acrylate) according to an embodiment of the present invention.

FIG. 3 is a schematic view of a rheometer, which is an apparatus for measuring the rheological properties of the gel polymer electrolyte based on poly(4-hydroxybutyl acrylate) according to an embodiment of the present invention.

FIG. 4 is a set of graphs showing the tan δ values over time for 16 examples in relation to the gel polymer electrolyte based on poly(4-hydroxybutyl acrylate) disclosed in the present invention.

FIG. 5 is a set of graphs showing the tanδ value of GPE depending on the volume fraction of a 1 M LiPF₆ solution, and a set of graphs showing the tanδ value of GPE depending on the relative volume ratio of HBA:PEGDA.

FIG. 6 is a set of graphs showing the crossing point where GPE changes from a viscoelastic liquid (1<tanδ) to a viscoelastic solid (tanδ<1) depending on the volume fraction of a 1 M LiPF₆ solution, and a set of graphs showing the crossing point where GPE changes from a viscoelastic liquid (1<tanδ) to a viscoelastic solid (tanδ<1) depending on the relative volume ratio of HBA:PEGDA.

FIG. 7 is a conceptual view illustrating a lap shear test of H-P GPE according to an embodiment of the present invention, a graph showing the lap shear strength of H-P GPE and C-P GPE depending on the relative volume ratio of monomer and PEGDA, and a graph showing the lap shear strength of H-P GPE depending on the volume fraction of a 1 M LiPF₆ solution.

FIG. 8 is a graph showing the storage modulus (G′) over time when GPE 8 in a pre-gel state is irradiated with UV light according to an embodiment of the present invention, and a set of actual images of GPE 8 when GPE 8 in a pre-gel state is irradiated with UV light for 5 minutes, 7 minutes, and 10 minutes, respectively.

FIG. 9 is a set of graphs showing the storage modulus (G′) and complex viscosity of a GPE according to an embodiment of the present invention.

FIG. 10 is a set of voltage-current curves based on LSV measurements of a GPE and a pre-gel solution according to an embodiment of the present invention, an impedance plot of GPEs according to embodiments of the present invention, and a graph of ionic conductivity of GPEs depending on crosslinking density.

FIG. 11 is a graph showing an FT-IR spectrum of the gel polymer electrolyte based on poly(4-hydroxybutyl acrylate) according to an embodiment of the present invention.

FIG. 12 is a graph showing FT-IR spectra of a gel polymer electrolyte based on poly(4-hydroxybutyl acrylate) and a gel polymer electrolyte based on ethylene oxide according to an embodiment of the present invention.

### DETAILED DESCRIPTION OF EMBODIMENTS

Hereinafter, a gel polymer electrolyte based on poly(4-hydroxybutyl acrylate) or poly(4-hydroxybutyl methacrylate) and a method for preparing the same in relation to the present invention will be described in more detail with reference to the accompanying drawings.

In the present specification, like reference numbers are used to designate like constituents even though they are in different Examples, and the description thereof will be omitted.

When it is determined that the detailed description of the publicly known art related in describing the Examples disclosed in the present specification may obscure the gist of the Examples disclosed in the present specification, the detailed description thereof will be omitted.

The accompanying drawings are provided to easily understand the Examples disclosed in the present specification, and it is to be appreciated that the technical spirit disclosed in the present specification is not limited by the accompanying drawings, and the accompanying drawings include all the modifications, equivalents, and substitutions included in the spirit and the technical scope of the present invention.

In the following description, singular expressions include plural expressions unless the context clearly indicates otherwise.

In the present application, the term “include” or “have” is intended to indicate the presence of a characteristic, number, step, operation, constituent element, part or any combination thereof described in the specification, and it should be understood that the possibility of the presence or addition of one or more other characteristics or numbers, steps, operations, constituent elements, parts or any combination thereof is not precluded.

Hereinafter, a gel polymer electrolyte based on poly(4-hydroxybutyl acrylate) or poly(4-hydroxybutyl methacrylate) and a method for preparing the same in relation to the present invention will be described in more detail with reference to the accompanying drawings.

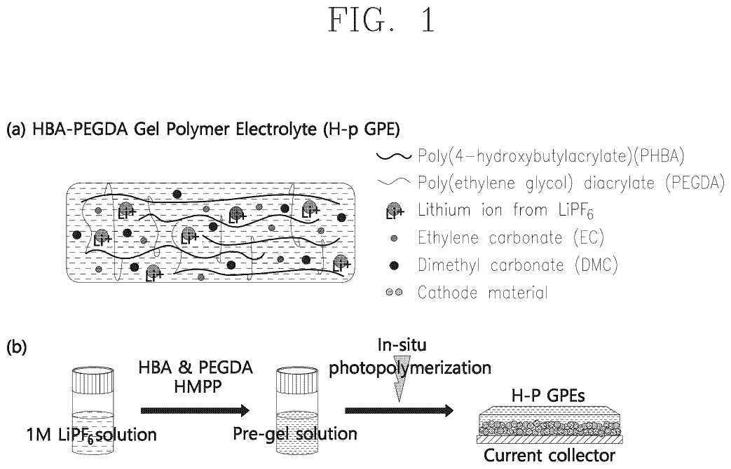

FIG. 1 is a schematic view of the gel polymer electrolyte based on poly(4-hydroxybutyl acrylate) according to an embodiment of the present invention, and a conceptual view showing a process for preparing the gel polymer electrolyte based on poly(4-hydroxybutyl acrylate).

Components of the gel polymer electrolyte based on poly(4-hydroxybutyl acrylate) according to an embodiment of the present invention will be described with reference to FIG. 1A.

The gel polymer electrolyte based on poly(4-hydroxybutyl acrylate) according to an embodiment of the present invention includes a polymer formed by polymerizing a monomer of 4-hydroxybutyl acrylate (hereinafter, referred to as HBA) represented by the following [Chemical Formula 1].

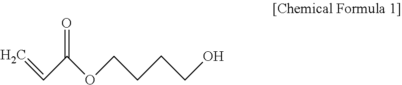

Hereinafter, the polymer formed by polymerizing the HBA monomer will be referred to as poly(4-hydroxybutyl acrylate) or PHBA.

PHBA is characterized by its excellent adhesion properties. This is because the hydroxyl group (—OH) present in the HBA provides hydrogen bonding.

Furthermore, the gel polymer electrolyte based on poly(4-hydroxybutyl acrylate) according to an embodiment of the present invention may include poly(ethylene glycol) diacrylate (hereinafter, PEGDA) represented by the following [Chemical Formula 3] as a crosslinking agent.

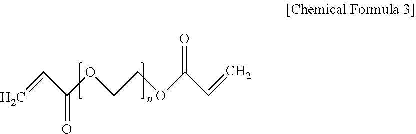

In this case, examples of another crosslinking agent include acrylate-or methacrylate- based materials such as 1,6-hexanediol diacrylate (HDDA), dipropylene glycol diacrylate (DPGDA), neopentyl glycol diacrylate (NPGDA), 1,2-propanediol diacrylate (PDDA), 1,3-butylene glycol diacrylate (BGDA), 1,4-butanediol diacrylate (BDDA), triethylene glycol diacrylate (TEGDA), tetraethylene glycol diacrylate (TetEGDA), pentaerythritol triacrylate (PETA), trimethylolpropane triacrylate (TMPTA), ethoxylated trimethylolpropane triacrylate (TMP3EOTA), trimethylolpropane trimethacrylate (TMPTMA), pentaerythritol tetraacrylate (PET4A), and dipentaerythritol hexaacrylate (DPHA), or vinyltriethoxysilane (CH₂=CHSi(OCH₂CH₃)₃), vinyltrimethoxysilane (CH₂=CHSi(OCH₃)₃), vinyl-tris-(₂-methoxyethoxy) silane (CH₂-CHSi(OCH₂CH₂OCH₃)₃), vinylmethyldimethoxysilane (CH₂=CHSiCH₃(OCH₃)₂), butyl melamine-based, isocyanate-based, metal chelate-based, and epoxy-based crosslinking agents, and the like. Crosslinking agents form chemical bonds between linear polymers, allowing the polymers to be linked together to form a polymer network structure. Therefore, the crosslinking agent may improve the strength, elasticity, heat resistance, cohesive force, and the like of the gel polymer electrolyte.

Further, the gel polymer electrolyte based on poly(4-hydroxybutyl acrylate) according to an embodiment of the present invention includes an electrolyte solution containing a salt.

The salt includes at least one selected from the group consisting of LiPF₆, LiBF₄, LiCO₄, LiAsF₆, LiSbF₆, LiPF₃(CF₂CF₃)₃, LiN(SO₂CF₃)₂, LiN(C₂F₅SO₂)₂, LiC (CF₃SO₂)₃, LiCF₃SO₃, LiC₄F₉SO₃, Li(CF₃SO₂)₂N, LiB(C₂O₄)₂ (LiBOB), LiC₂F₆NO₄S₂ (LiTFSI), LiPO₂F₂, lithium difluorobisoxalato phosphate (LiDFOP), and lithium difluoro (oxalato) borate (LiDFOB). In this case, lithium ions are dissociated from the salt. When a lithium ion battery is charged, lithium ions move from the positive electrode to the negative electrode, and when a lithium ion battery is discharged, lithium ions move from the negative electrode to the positive electrode.

The salt is dissolved in an electrolyte solution, and the electrolyte solution includes at least one selected from the group consisting of carbonate-based electrolytes including ethylene carbonate (EC), dimethyl carbonate (DMC), propylene carbonate (PC), diethyl carbonate (DEC), fluoroethylene carbonate (FEC), ethylmethyl carbonate (EMC), methylpropyl carbonate (MPC), ethylpropyl carbonate (EPC), butylene carbonate (BC), and the like. The electrolyte solution should be a material having high ionic conductivity for smooth movement of lithium ions, and is characterized in that it should have high electrochemical stability and high ignition point for safety.

Hereinafter, a method for preparing the gel polymer electrolyte based on poly(4-hydroxybutyl acrylate) according to an embodiment of the present invention will be described in more detail with reference to FIG. 1B.

### Example

### 1. Preparation of Materials for Gel Polymer Electrolyte

4-hydroxybutyl acrylate (HBA, ≥95.0%) was purchased from Tokyo Chemical Industry Co., Ltd.

Poly(ethylene glycol) diacrylate (PEGDA, 99%, Mn about 575 g/mol), carbitol acrylate (CA, ≥90%), and 2-hydroxy-2-methylpropiophenone (HMPP, 97%) were purchased from Merck.

A commercial liquid electrolyte (LB301, 1 M LiPF₆ in EC:DMC (1:1, v:v)) was purchased from Soulbrain Co., Ltd., Korea, and was used without any other additives.

HBA, PEGDA, and CA were purified with aluminum oxide and then used, such that an inhibitor was removed.

### 2. Preparation of Electrolyte Solution Containing Lithium Salt

LiPF₆ is added to an electrolyte solvent with a volume ratio of ethylene carbonate (EC) to dimethyl carbonate (DMC) of 1:1 to prepare a 1 M LiPF₆ solution.

### 3. Production of Pre-Gel Solution

HBA, PEGDA, and HMPP, a photoinitiator, were added to the 1 M LiPF₆ solution produced in No. 2 to prepare a pre-gel solution.

In this case, the volume fractions of the remaining components of the pre-gel solution except for HMPP are as follows:
1M LiPF₆ solution: 80.0 vol % to 95.0 vol %
HBA: 4.00 vol % to 19.80 vol %
PEGDA: 0.05 vol % to 4.00 vol %

In addition, among the components of the pre-gel solution, HMPP was added in an amount of 5 vol % of the total content of the monomer (HBA) and the crosslinking agent (PEGDA).

Furthermore, in this case, the relative volume ratio of the HBA to the PEGDA is 1:99 to 99:1.

In this example, the relative volume ratio of the HBA to the PEGDA was set to 65:35 to 99:1.

### 4. In-situ Photopolymerization Reaction

The pre-gel solution produced in No. 3 was applied onto an electrode, and the pre-gel solution was irradiated with UV light (365 nm, 4 W) for 6 minutes to cause a photopolymerization reaction, producing an HBA-PEGDA gel polymer electrolyte (hereinafter, referred to as H-P GPE or GPE).

### 5. Production of Control

A CA-PEGDA gel polymer electrolyte (hereinafter, referred to as C-P GPE) was produced by the same procedures as Nos. 2 to 4 above using carbitol acrylate (CA) instead of HBA as a monomer.

In addition, an HBA gel polymer electrolyte (hereinafter, referred to as H-GPE) was produced by the same procedures as Nos. 2 to 4 above using HBA alone without including PEGDA.

Furthermore, a PEGDA gel polymer electrolyte (hereinafter, referred to as P-GPE) was produced by the same procedures as Nos. 2 to 4 above using PEGDA alone without including HBA.

### Example 2

A method for preparing a gel polymer electrolyte based on poly(4-hydroxybutyl methacrylate) according to an embodiment of the present invention involves performing steps 1 to 4 above in the same manner as described above, except that 4-hydroxybutyl methacrylate (hereinafter, referred to as HBMA) represented by the following [Chemical Formula 2] is used instead of 4-hydroxybutyl acrylate of No. 1 in [Example 1].

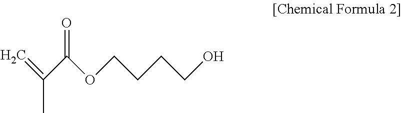

Further, the method for preparing a gel polymer electrolyte based on poly(4-hydroxybutyl acrylate) or poly(4-hydroxybutyl methacrylate) according to an embodiment of the present invention includes a polymerization initiator.

The polymerization initiator includes a photoinitiator or a thermal initiator.

In this case, the photoinitiator includes at least one selected from the group consisting of 2-hydroxy-2-methylpropiophenone (HMPP), 1-hydroxycyclohexyl phenyl ketone (HCPK), diphenyl(2,4,6-trimethylbenzoyl) phosphine oxide (TPO), phenylbis(2,4,6-trimethylbenzoyl)phosphine oxide (BAPO), or Type I photoinitiator and Type II photoinitiator, or a compound capable of generating radicals by light.

In addition, the thermal initiator includes at least one selected from the group consisting of azobisisobutyronitrile (AIBN), benzoyl peroxide (BPO), or a compound capable of generating radicals by heat.

Sixteen examples of H-P GPE produced through steps 1 to 4 of [Example 1] are shown in the following [Table 1].

TABLE 1

| | | | | 1M LiPF₆ solution |
|---|---|---|---|---|
| | HBA:PEGDA | HBA | PEGDA | in EC:DMC |
| No. | (v:v) | (vol %) | (vol %) | (vol %) |
| GPE 1 | 99:1 | 4.95 | 0.05 | 95.0 |
| GPE 2 | 95:5 | 4.75 | 0.25 | 95.0 |
| GPE 3 | 90:10 | 4.50 | 0.50 | 95.0 |
| GPE 4 | 80:20 | 4.00 | 1.00 | 95.0 |
| GPE 5 | 99:1 | 9.90 | 0.10 | 90.0 |
| GPE 6 | 95:5 | 9.50 | 0.50 | 90.0 |
| GPE 7 | 90:10 | 9.00 | 1.00 | 90.0 |
| GPE 8 | 80:20 | 8.00 | 2.00 | 90.0 |
| GPE 9 | 99:1 | 14.85 | 0.15 | 85.0 |
| GPE 10 | 95:5 | 14.25 | 0.75 | 85.0 |
| GPE 11 | 90:10 | 13.50 | 1.50 | 85.0 |
| GPE 12 | 80:20 | 12.00 | 3.00 | 85.0 |
| GPE 13 | 99:1 | 19.80 | 0.20 | 80.0 |
| GPE 14 | 95:5 | 19.00 | 1.00 | 80.0 |
| GPE 15 | 90:10 | 18.00 | 2.00 | 80.0 |
| GPE 16 | 80:20 | 16.00 | 4.00 | 80.0 |

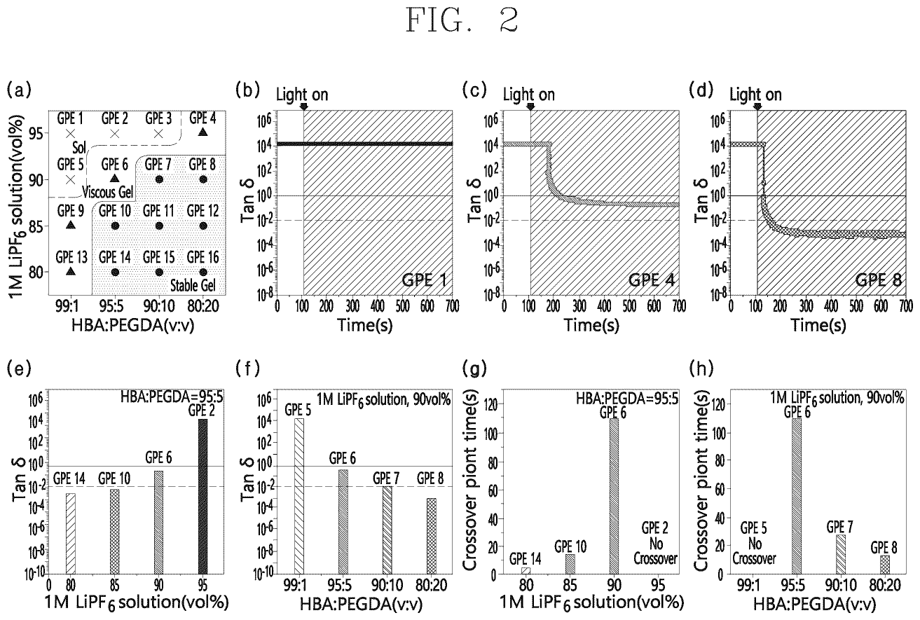

FIG. 2 is a set of graphs relating to the gelation suitability of the gel polymer electrolyte based on poly(4-hydroxybutyl acrylate) according to an embodiment of the present invention.

In the present invention, the tanδ value was used as an index to confirm the gelation suitability of 16 types of pre-gel solutions.

In this case, tanδ is a value defined as the ratio between G″ (loss modulus) and G′ (storage modulus), and is represented by the following [Equation 1].

$$tan δ = \frac{{G}^{″}}{{G}^{′}} \qquad [ Equation 1 ]$$

When a material has a measured tanδ value greater than 1, the material is considered to be a viscoelastic liquid, and when a material has a measured tan δ value greater than 10², the material is generally considered to be an ideal viscous liquid. In contrast, when a material has a measured tanδ value less than 1, the material is considered to be a viscoelastic solid, and when a material has a measured tanδ value less than 10⁻², the material is considered to be an ideal elastic solid.

Hereinafter, the gelation suitability of the gel polymer electrolyte based on poly(4-hydroxybutyl acrylate) according to an embodiment of the present invention will be described in more detail with reference to FIGS. 2 to 6.

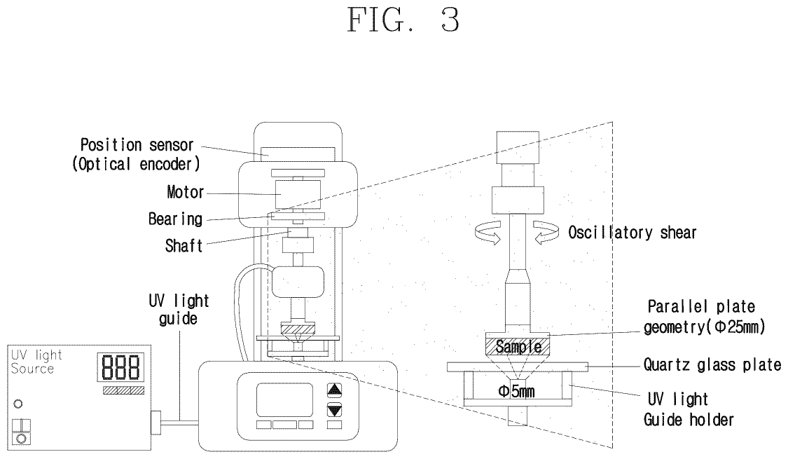

FIG. 3 illustrates a schematic view of a rheometer, which is an apparatus for measuring the rheological properties of the gel polymer electrolyte based on poly(4-hydroxybutyl acrylate) according to an embodiment of the present invention.

The sol-gel transition of 16 types of H-P GPE was monitored using an MCR702 rheometer (Anton Paar GmbH). In this case, the rheological properties over time were measured using two parallel plates (diameter=25 mm) under the conditions in which the fixed frequency of the rheometer was 10 rad/s and the fixed shear stress of the rheometer was 5%. The pre-gel solution was irradiated with UV light (365 nm) 120 seconds after the start of the measurement.

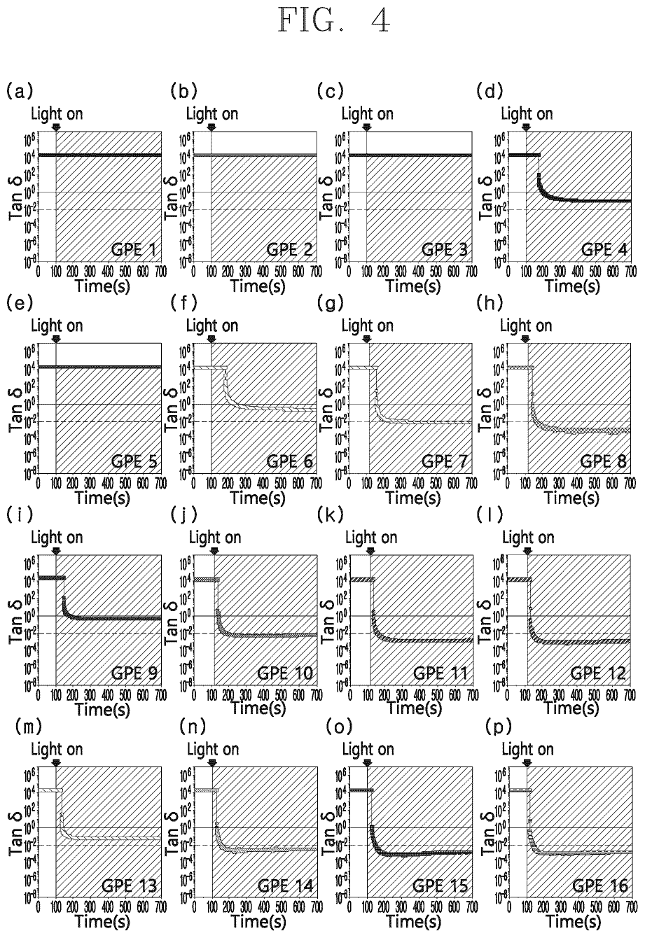

FIG. 4 is a set of graphs showing the tanδ values over time for 16 examples in relation to the gel polymer electrolyte based on poly(4-hydroxybutyl acrylate) disclosed in the present invention.

According to the measured tanδ values, the gelation suitability of the 16 types of H-P GPE may be classified as follows.
No gelation: 1<tanδ(GPE 1, 2, 3, 5)
Viscous gel formation: 10⁻²<tanδ<1 (GPE 4, 6, 9, 13)
Stable gel formation: tanδ<10⁻² (GPE 7, 8, 10, 11, 12, 14, 15, 16)

FIG. 2A illustrates the gelation suitability of H-P GPE depending on the relative volume ratio of HBA:PEGDA and the volume fraction of the 1 M LiPF₆ solution.

FIGS. 2B, 2C, and 2D are graphs showing the tanδ values of GPE 2, GPE 6, and GPE 8, respectively, over time.

Referring to FIG. 2B, the tanδ value of the pre-gel solution of GPE2, in which the relative volume ratio of HBA:PEGDA is 95:5, does not change with time. Thus, GPE 2 was not gelled during the time period measured.

Referring to FIG. 2C, the pre-gel solution of GPE6 with a volume fraction of 90% of the 1 M LiPF₆ solution has a tanδ value that decreases to less than 1 after being irradiated with UV light. This resulted in the formation of a polymer network in the liquid solution, resulting in the viscous gelation of GPE6.

Referring to FIG. 2D, the pre-gel solution of GPE 8 having a relative volume ratio of HBA:PEGDA of 80:20 and a volume fraction of the 1 M LiPF₆ solution of 95% significantly decreased in tanδ value to less than 10⁻² over time. Therefore, GPE 8 was stably gelled.

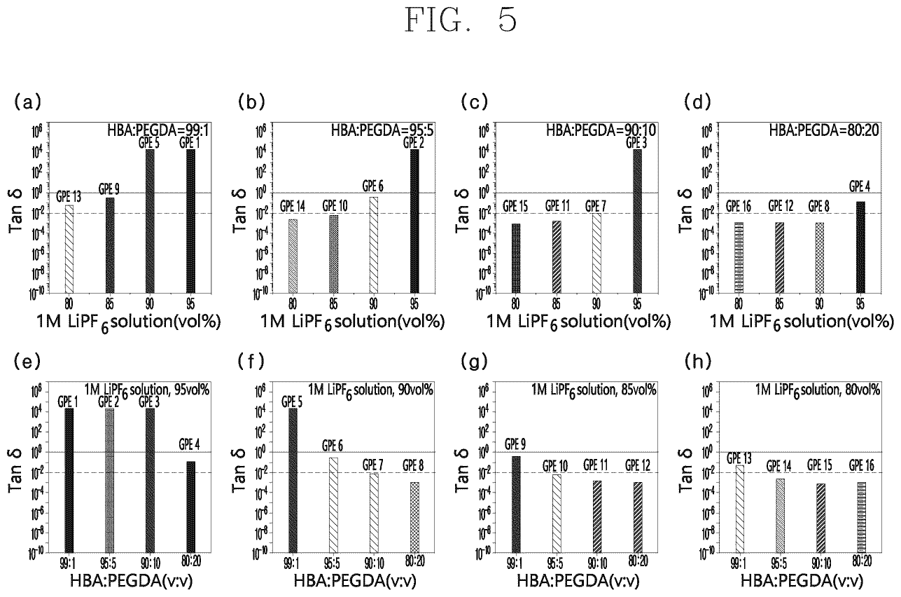

FIG. 5 is a set of graphs showing the tanδ value of GPE depending on the volume fraction of a 1 M LiPF₆ solution, and a set of graphs showing the tanδ value of GPE depending on the relative volume ratio of HBA:PEGDA.

Referring to FIG. 2E, the tanδ value significantly decreases from 2×10⁴ (GPE 2) to 2.47×10⁻³ (GPE 14) as the volume fraction of the 1 M LiPF₆ solution decreases from 95 vol % to 80 vol % (that is, as the content of the polymer in the GPE increases). This indicates that the more polymer content in GPE, the more stable the gel formed.

Referring to FIG. 2F, the value of tanδ decreases from 2×10⁴ (GPE 5) to 9.36×10⁻⁴ (GPE 8) as the relative volume ratio of HBA:PEGDA changes from 99:1 to 80:20. This indicates that the more dense the network formed by the crosslinking agent in the GPE, the more stable the gel formed.

Furthermore, referring to FIGS. 2G and 2H, the material design of GPE also affects the gelation rate. As the contents of the polymer and the crosslinking agent in the GPE increase, a crossover point where the GPE changes from a viscoelastic liquid (1<tanδ) to a viscoelastic solid (tanδ<1) appears earlier.

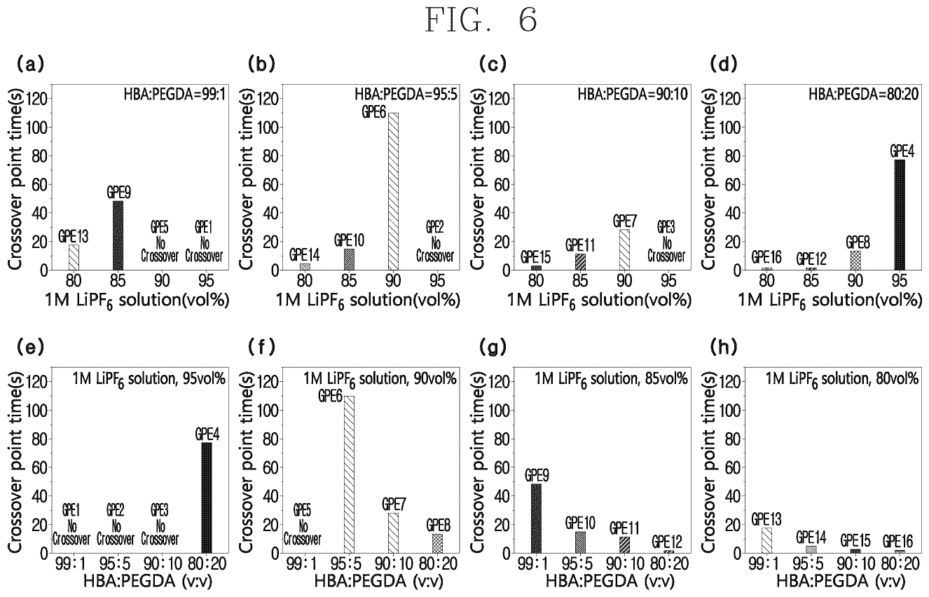

FIG. 6 is a set of graphs showing the crossing point where GPE changes from a viscoelastic liquid (1 <tanδ) to a viscoelastic solid (tanδ<1) depending on the volume fraction of a 1 M LiPF₆ solution, and a set of graphs showing the crossing point where GPE changes from a viscoelastic liquid (1<tanδ) to a viscoelastic solid (tanδ<1) depending on the relative volume ratio of HBA:PEGDA.

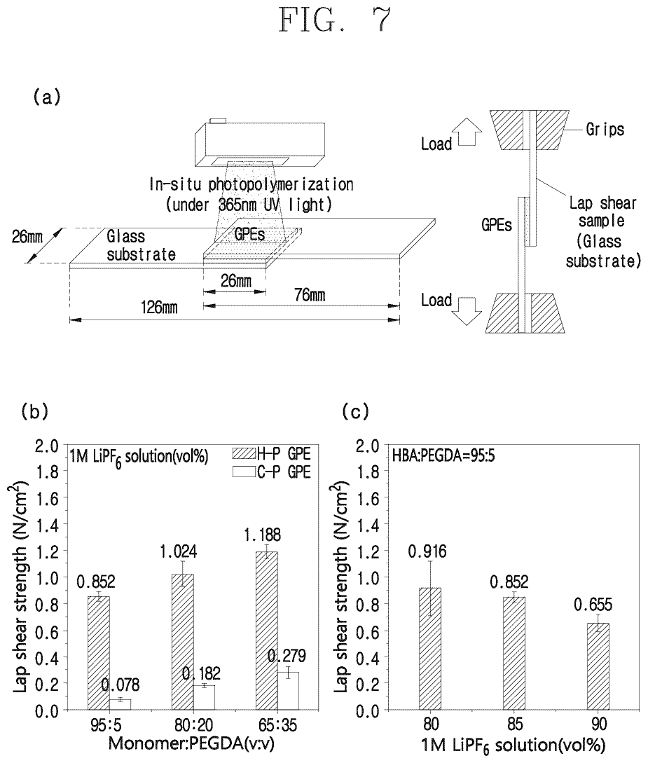

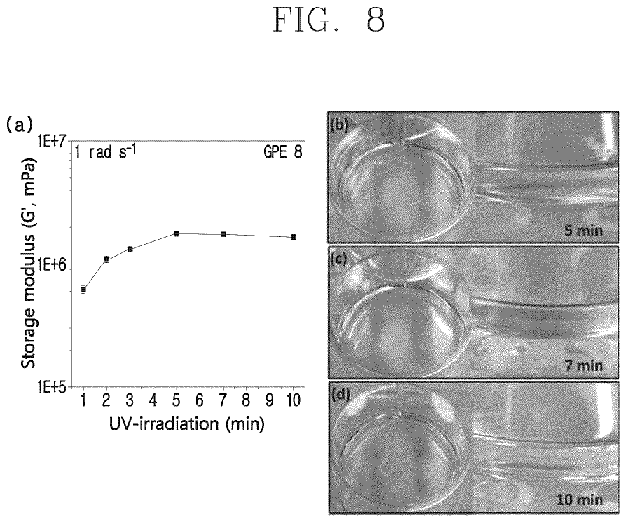

Hereinafter, the adhesion of the gel polymer electrolyte based on poly(4-hydroxybutyl acrylate) according to an embodiment of the present invention will be described with reference to FIGS. 7 to 8. The adhesion of H-P GPE is measured by the lap shear strength of H-P GPE.

FIG. 7A is a conceptual view illustrating the lap shear test of H-P GPE.

The H-P GPE liquid in the pre-gel state was placed between two transparent slide glass substrates (Marienfeld Superior, 76 mm×26 mm) so as to fill an area of 26 mm×26 mm. The test specimen is then irradiated with UV light (365 nm) to cause an in-situ photopolymerization reaction.

A lap shear test was performed using a Universal/Tensile Testing Machine (UTM, OTT-033, Oriental TM) at a travel speed of 1.3 mm/min (0.05 in/min).

As a control, C-P GPE using carbitol acrylate (CA) represented by the following [Chemical Formula 4] as a monomer is also subjected to the lap shear test through the same test specimen preparation process as above.

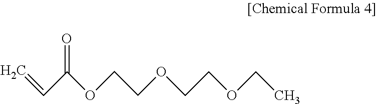

The lap shear strength (σₜ) is represented by the following [Equation 2].

$${σ}_{t} = \frac{{W}_{max}}{{A}_{0}} \qquad [ Equation 2 ]$$

Here, Wmax is the maximum shear load when the test specimen breaks, and Ao is the contact area of the test specimen before the test.

FIG. 7B is a graph showing the lap shear strength of H-P GPE and C-P GPE depending on the relative volume ratio of monomer to PEGDA.

Referring to FIG. 7B, as a result of performing a lap shear test using GPEs with a relative volume ratio of monomer (HBA, CA) and crosslinking agent PEGDA of 95:5, 80:20, and 65:35, respectively, H-P GPE exhibits a lap shear strength that is 10.92-fold, 5.67-fold, and 4.26-fold higher than C-P GPE, respectively. In this case, as the content of the crosslinking agent decreases, the lap shear strength of H-P GPE tends to increase more than that of C-P GPE, which is due to the increase in the content of the monomer (HBA or CA). Therefore, H-P GPE including HBA with a hydroxyl group (-OH) has improved adhesion compared to a C-P GPE, which is composed of an ether bond, widely used in the related art.

Further, when the relative volume ratio of the monomer to the crosslinking agent PEGDA in H-P GPE changes from 95:5 to 65:35, respectively, the lap shear strength increases from 0.85N/cm² to 1.19 N/cm². This may be due to an increase in polymer bonding strength caused by the high crosslinking density in the polymer network.

FIG. 7C is a graph showing the lap shear strength of H-P GPE depending on the volume fraction of the 1 M LiPF₆ solution.

Referring to FIG. 7C, as the liquid content in H-P GPE increases, the lap shear strength of H-P GPE decreases. This is because the mechanical properties decreased due to the decrease in the content of the polymer in H-P GPE.

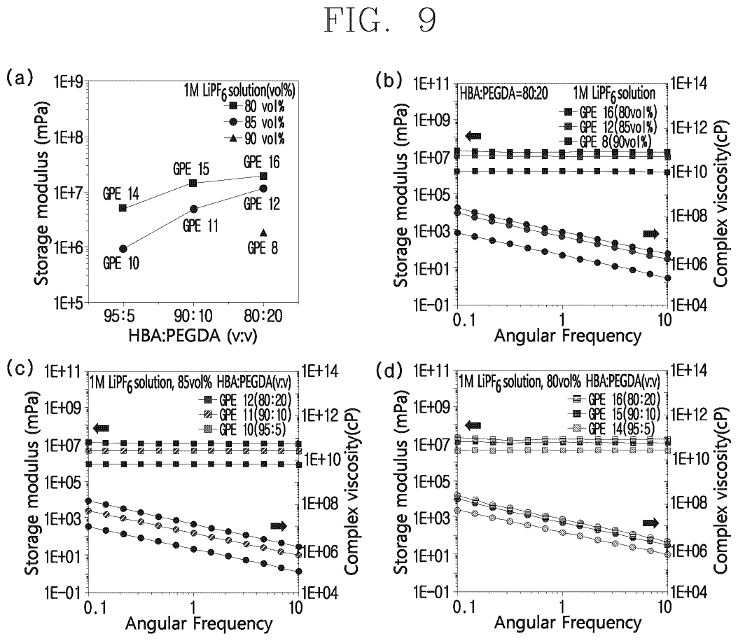

Hereinafter, the rheological properties of the gel polymer electrolyte based on poly(4-hydroxybutyl acrylate) according to an embodiment of the present invention will be described with reference to FIGS. 8 to 9.

FIG. 8A is a graph showing the storage modulus (G′) over time when GPE 8 in a pre-gel state is irradiated with UV light according to an embodiment of the present invention.

The storage modulus of each GPE according to an embodiment of the present invention was measured using an MCR 302 rheometer (Anton Paar GmbH). In this case, the storage modulus of GPE was measured using parallel plates (diameter=8 mm) under the conditions in which the angular frequency of the rheometer was 0.1 rad/s to 10 rad/s and the shear stress of the rheometer was 5%.

Referring to FIG. 8A, it is possible to confirm the change in the storage modulus of GPE 8 when GPE 8 in a pre-gel state is irradiated with UV light for 1 minute, 2 minutes, 3 minutes, 5 minutes, 7 minutes, and 10 minutes, respectively. The storage modulus gradually increases until a time point of 5 minute, and does not change significantly from a time point when 6 minutes have passed to a time of 10 minute.

FIGS. 8B, 8C and 8D are actual images of GPE 8 when GPE 8 in a pre-gel state is irradiated with UV light for 5 minutes, 7 minutes, and 10 minutes, respectively.

FIG. 9 is a set of graphs showing the storage modulus (G′) and complex viscosity of a GPE which formed a stable gel according to an embodiment of the present invention.

Since GPE is a semi-solid electrolyte and also acts as a separator in a lithium ion battery, the mechanical properties of GPE are important. The mechanical properties of the GPE according to the material design of GPE were measured based on the rheological properties of the GPE.

The storage modulus (G′) and complex viscosity of the GPE which formed a stable gel were measured under the conditions in which the angular frequency changed from 0.1 rad/s to 10 rad/s and the oscillatory shear stress was 5%.

The storage modulus (G′) is directly related to the solid-state properties of the GPE and represents the elastic part of the viscoelastic behavior of the GPE. The larger the storage modulus of the GPE, the better the mechanical properties of the GPE.

The complex viscosity is one of the indices that show the viscosity of GPE, and the smaller the complex viscosity of GPE, the greater the flowability of the GPE and the lower its structural stability.

Referring to FIGS. 9A, 9B, 9C, and 9D, the storage modulus of the GPE increases as the content of the liquid in the GPE decreases. The storage moduli of GPE 8 (90 vol %), GPE 12 (85 vol %), and GPE 16 (80 vol %) with different contents of the 1 M LiPF₆ solution increased to 1.73 kPa, 11.50 kPa, and 19.01 kPa, respectively, due to the increase in the content of polymer chains in GPE.

In addition, the storage modulus of GPE increases as the content of the crosslinking agent (PEGDA) in GPE increases. The storage moduli of GPE 10 (95:5), GPE 11 (90:10) and GPE 12 (80:20) with different relative volume ratios of monomer (HBA):crosslinking agent (PEGDA) increase to 0.92 kPa, 4.74 kPa and 11.50 kPa, respectively. This is because the crosslinking density increases as the content of the crosslinking agent in GPE increases. In a GPE with a relatively high content of crosslinking agent, a polymer structure with a strong network morphology is formed.

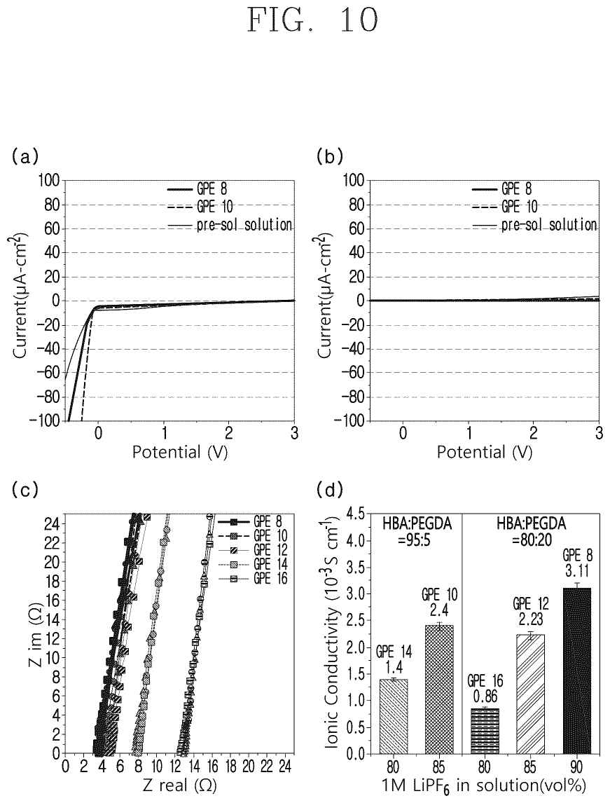

Hereinafter, the electrochemical stability and ionic conductivity of the gel polymer electrolyte based on poly(4-hydroxybutyl acrylate) according to an embodiment of the present invention will be described with reference to FIG. 10.

The electrochemical stability of an H-P GPE or pre-gel solution when the H-P GPE or pre-gel solution was applied to a lithium ion battery was measured using linear sweep voltammetry (LSV).

LSV was performed using a battery tester system (WBCS 3000, WonA tech.). In this case, a Cu/GPE/Li cell with a potential range of 3.0 V to-1.0 V and an Al/GPE/Li cell with a potential range of 3.0 V to 5.0 V were prepared. Cu in the Cu/GPE/Li cell and Al in the Al/GPE/Li cell were the working electrodes, and Li was used as a counter electrode and a reference electrode. The LSV was measured at a scan rate of 1 mV/s. The prepared cells have an open circuit potential (OCV) about 3.0 V.

FIGS. 10A and 10B are voltage-current curves of GPEs and a pre-gel solution according to an embodiment of the present invention.

Referring to FIGS. 10A and 10B, H-P GPE exhibits electrochemical stability suitable for lithium ion batteries because a negligible current of less than 5 μA/cm² was detected in a potential range of 0 V to 5 V.

The ionic conductivity of H-P GPE when applied to a lithium ion battery was measured through electrochemical impedance spectroscopy (EIS).

EIS was performed at room temperature using a ZIVE SP₁ electrochemical workstation (WonA Tech.) with an amplitude of 0.01 V and a frequency range of 0.1 MHz to 0.1 Hz.

In this case, a cell was assembled by inserting H-P GPE between two stainless steel electrodes (diameter=16 mm, thickness=1 mm), and the distance between the electrodes was maintained using a PP ring spacer (outer diameter=16 mm, inner diameter=14 mm, and thickness=0.167 mm).

Ionic conductivity (δ) is represented by the following [Equation 3].

$$δ = \frac{d}{{R}_{b} S} \qquad [ Equation 3 ]$$

Here, d is the thickness of H-P GPE, R_{b} is the bulk resistance of H-P GPE, and S is the contact area of H-P GPE.

Referring to FIG. 10C, in an impedance plot for measuring ionic conductivity, straight lines appear on the graph, and the intersection with the x-axis indicates the bulk resistance.

Referring to FIG. 10D, the ionic conductivity of GPEs (GPE 8, GPE 12, and GPE 16) having the same HBA:PEGDA ratio (80:20, v:v) increases as the liquid content increases from 80 vol % to 90 vol %. Furthermore, when comparing GPE10 and GPE14, which have the same

HBA:PEGDA ratio (95:5, v:v), the ionic conductivity increases as the liquid content increases from 80 vol % to 85 vol %. This is because the amount of lithium ions increases and the content of networked polymer chains capable of hindering the movement of lithium ions decreases, when the liquid content in the GPE increases.

Hereinafter, the ionic conductivity of GPE depending on the crosslinking density will be described with reference to FIG. 10D.

When comparing GPE 10 with an HBA:PEGDA ratio of 95:5 and GPE 12 with an HBA:PEGDA ratio of 80:20, the ionic conductivity of GPE 10 (2.4×10⁻³ S/cm) is shown to be higher than that of GPE 12 (2.23×10⁻³ S/cm). This is because the movement of ions is hindered in GPE 12 whose polymer network has a high crosslinking density.

Likewise, when comparing GPE 14 with an HBA:PEGDA ratio of 95:5 and GPE 16 with an HBA:PEGDA ratio of 80:20, the ionic conductivity of GPE 14 (1.4×10⁻³ S/cm) is shown to be higher than that of GPE 16 (0.86×10⁻³ S/cm).

Further, when the ionic conductivity of GPE 8 (3.11×10⁻³ S/cm) is compared with that of GPE 12 (2.23×10⁻³ S/cm), that of GPE 10 (2.4×10⁻³ S/cm), and that of GPE 12 (2.23×10⁻³ S/cm), an increase in the content of the liquid electrolyte (1 M LiPF₆ solution) in the GPEs (comparison between GPE 8 and GPE 12) is more effective in improving the ionic conductivity of the GPEs than a decrease in the crosslinking density in the GPEs (comparison between GPE 10 and GPE 12).

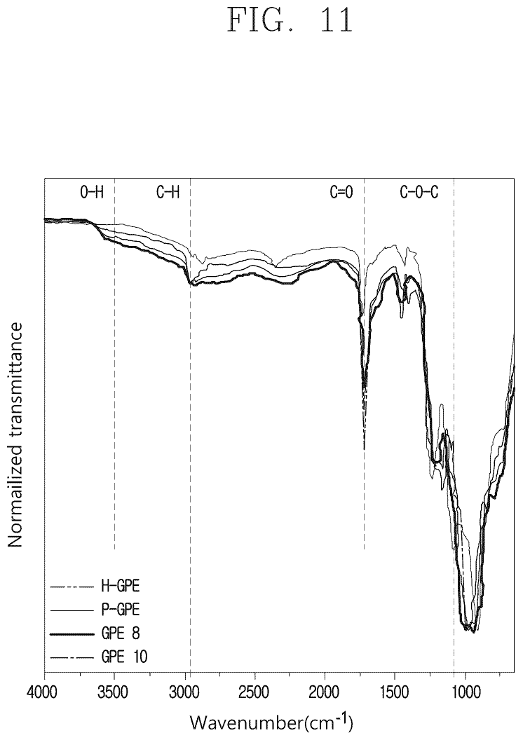

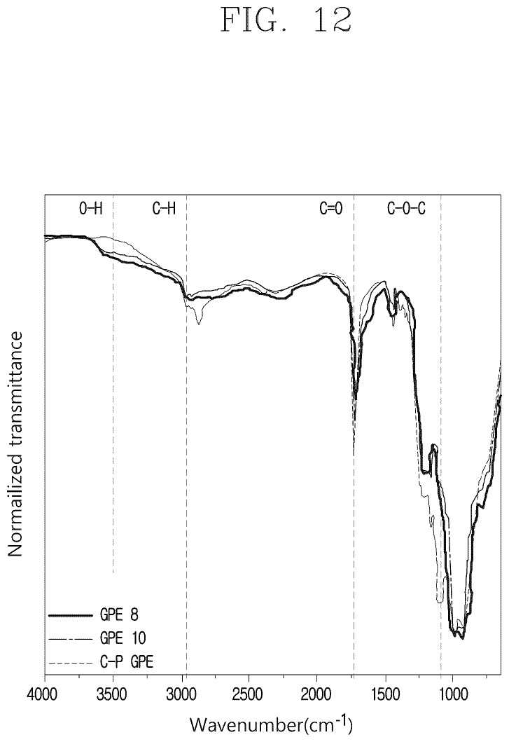

Hereinafter, the FT-IR spectrum of the gel polymer electrolyte based on poly(4-hydroxybutyl acrylate) according to an embodiment of the present invention will be described with reference to FIGS. 11 to 12.

Fourier transform infrared (FT-IR) analysis was performed in a wavelength range of 650 cm⁻¹ to 4000 cm⁻¹ using an FT-IR spectrometer (Nicolet 380, Thermo Fisher Scientific Co.). Samples were dried at 80° C. under vacuum prior to the FT-IR analysis.

FIGS. 11 and 12 are graphs showing FT-IR spectra of the gel polymer electrolyte based on poly(4-hydroxybutyl acrylate) according to an embodiment of the present invention.

Referring to FIG. 11, the H-GPE including no PEGDA, produced by a method for preparing the gel polymer electrolyte based on poly(4-hydroxybutyl acrylate) according to an embodiment of the present invention, shows a broad band in a range of 3500 cm⁻¹ to 3200 cm⁻¹ This is derived from the hydroxyl group (—OH) of H-GPE.

In contrast, in the case of P-GPE that does not include HBA and is produced by a method for preparing the gel polymer electrolyte based on poly(4-hydroxybutyl acrylate) according to an embodiment of the present invention, a peak is observed at about 1080 cm⁻¹, which corresponds to the ether bond (R—O—R′) of PEGDA.

In the case of H-P GPE (GPE8 and GPE10), unlike H-GPE, an ether bond is formed, and thus, a shoulder band is observed at about 1080 cm⁻¹. From these results, it can be confirmed that H-P GPE, the gel polymer electrolyte based on poly(4-hydroxybutyl acrylate) according to an embodiment of the present invention, was successfully photopolymerized by forming a polymer network including both HBA and PEGDA.

Referring to FIG. 12, a peak is clearly observed at about 1080 cm⁻¹ for C-P GPE produced by a method for producing the gel polymer electrolyte based on poly(4-hydroxybutyl acrylate) according to an embodiment of the present invention, using CA instead of HBA as a monomer. This is derived from the ether bond (R—O—R′) of C-P GPE.

In addition, C-P GPE does not exhibit a broad band in a range of 3500 cm⁻¹ to 3200 cm⁻¹, which is due to the absence of a hydroxyl group (—OH) in C-P GPE.

The above-described content is merely illustrative, and various modifications may be made by a person having ordinary skill in the art to which the present invention pertains without departing from the scope and technical spirit of the described embodiments. The above-described embodiments may be implemented individually or in any combination.

What is claimed is:

1. A gel polymer electrolyte comprising: a polymer formed by polymerizing a monomer of 4-hydroxybutyl acrylate (HBA) represented by the following Chemical Formula 1 or a monomer of 4-hydroxybutyl methacrylate (HBMA) represented by the following Chemical Formula 2; and a crosslinking agent,

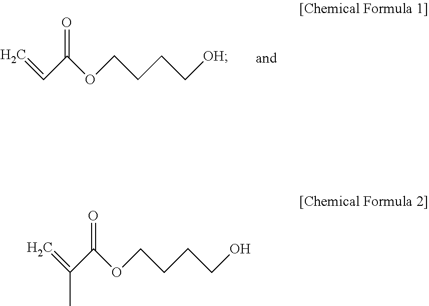

2. The gel polymer electrolyte of claim 1, wherein a relative volume ratio of the monomer to the crosslinking agent is 1:99 to 99:1.

3. The gel polymer electrolyte of claim 1, wherein a relative volume ratio of the monomer to the crosslinking agent is 65:35 to 99:1.

4. The gel polymer electrolyte of claim 1, wherein the crosslinking agent is composed of an acrylate-or methacrylate-based material.

5. The gel polymer electrolyte of claim 1, wherein the crosslinking agent comprises at least one selected from the group consisting of poly(ethylene glycol) diacrylate (PEGDA), 1,6-hexanediol diacrylate (HDDA), dipropylene glycol diacrylate (DPGDA), neopentyl glycol diacrylate (NPGDA), 1,2-propanediol diacrylate (PDDA), 1,3-butylene glycol diacrylate (BGDA), 1,4-butanediol diacrylate (BDDA), triethylene glycol diacrylate (TEGDA), tetraethylene glycol diacrylate (TetEGDA), pentaerythritol triacrylate (PETA), trimethylolpropane triacrylate (TMPTA), ethoxylated trimethylolpropane triacrylate (TMP3EOTA), trimethylolpropane trimethacrylate (TMPTMA), pentaerythritol tetraacrylate (PET4A), dipentaerythritol hexaacrylate (DPHA), vinyltriethoxysilane (CH2=CHSi (OCH2CH3) 3), vinyltrimethoxysilane (CH₂=CHSi(OCH₃)₃), vinyl-tris-(2-methoxyethoxy) silane (CH₂=CHSi(OCH₂CH₂OCH₃)₃), vinylmethyldimethoxysilane (CH₂=CHSiCH₃(OCH₃)₂), butyl melamine-based, isocyanate-based, metal chelate-based, and epoxy-based crosslinking agents.

6. The gel polymer electrolyte of claim 1, further comprising an electrolyte solution containing a salt.

7. The gel polymer electrolyte of claim 6, wherein the salt comprises at least one selected from the group consisting of LiPF₆, LiBF₄ , LiClO₄ , LiAsF₆, LiSbF₆, LiPF₃(CF₂CF₃)₃, LiN(SO₂CF₃)₂, LiN(C₂F₅SO₂)₃, LiC(CF₃SO₂)₃, LiCF₃SO₃, LiC₄F₉SO₃, Li(CF₃SO₂)₂N, LiB(C₂O₄)₂ (LiBOB), LiC₂F₆NO₄S₂ (LiTFSI), LiPO₂F₂, lithium difluorobisoxalato phosphate (LiDFOP), and lithium difluoro (oxalato) borate (LiDFOB), and
the electrolyte solution comprises at least one selected from the group consisting of carbonate-based electrolytes comprising ethylene carbonate (EC), dimethyl carbonate (DMC), propylene carbonate (PC), diethyl carbonate (DEC), fluoroethylene carbonate (FEC), ethylmethyl carbonate (EMC), methylpropyl carbonate (MPC), ethylpropyl carbonate (EPC), butylene carbonate (BC), and the like.

8. The gel polymer electrolyte of claim 1, wherein the gel polymer electrolyte has a tanδ value of 1 or less, and
the tanδ is a value defined as G″ (loss modulus)/G′ (storage modulus).

9. A method for preparing a gel polymer electrolyte, the method comprising: adding 4-hydroxybutyl acrylate (HBA) represented by the following Chemical Formula 1 or 4-hydroxybutyl methacrylate (HBMA) represented by the following Chemical Formula 2 as a monomer to an electrolyte solution containing a salt, and adding a crosslinking agent and a polymerization initiator to the electrolyte solution to produce a pre-gel solution; and
an in-situ process step of applying the pre-gel solution onto an electrode and then initiating a polymerization reaction,

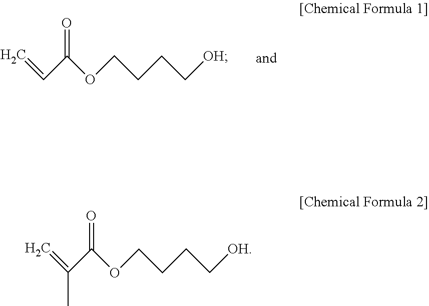

10. The method of claim 9, wherein the salt comprises at least one selected from the group consisting of LiPF₆ , LiBF₄, LiClO₄ , LiAsF₆, LiSbF₆, LiPF₃(CF₂CF₃)₃, LiN (SO₂CF₃)₂, LiN(C₂F₅SO₂)₂, LiC(CF₃SO₂)₃, LiCF₃SO₃, LiC₄F₉SO₃, Li(CF₃SO₂)₂N, LiB(C₂O₄)₂ (LiBOB), LiC₂F₆NO₄S₂ (LiTFSI), LiPO₂F₂, lithium difluorobisoxalato phosphate (LiDFOP), and lithium difluoro (oxalato) borate (LiDFOB), and
the electrolyte solution comprises at least one selected from the group consisting of carbonate-based electrolytes comprising ethylene carbonate (EC), dimethyl carbonate (DMC), propylene carbonate (PC), diethyl carbonate (DEC), fluoroethylene carbonate (FEC), ethylmethyl carbonate (EMC), methylpropyl carbonate (MPC), ethylpropyl carbonate (EPC), butylene carbonate (BC), and the like.

11. The method of claim 9, wherein the crosslinking agent is composed of an acrylate-based or methacrylate-based material.

12. The method of claim 9, wherein the crosslinking agent comprises at least one selected from the group consisting of poly(ethylene glycol) diacrylate (PEGDA), 1,6-hexanediol diacrylate (HDDA), dipropylene glycol diacrylate (DPGDA), neopentyl glycol diacrylate (NPGDA), 1,2-propanediol diacrylate (PDDA), 1,3-butylene glycol diacrylate (BGDA), 1,4-butanediol diacrylate (BDDA), triethylene glycol diacrylate (TEGDA), tetraethylene glycol diacrylate (TetEGDA), pentaerythritol triacrylate (PETA), trimethylolpropane triacrylate (TMPTA), ethoxylated trimethylolpropane triacrylate (TMP3EOTA), trimethylolpropane trimethacrylate (TMPTMA), pentaerythritol tetraacrylate (PET4A), dipentaerythritol hexaacrylate (DPHA), vinyltriethoxysilane (CH₂=CHSi(OCH₂CH₃)₃), vinyltrimethoxysilane (CH₂=CHSi(OCH₃)₃), vinyl-tris-(2-methoxyethoxy) silane (CH₂=CHSi(OCH₂CH₂OCH₃)₃), vinylmethyldimethoxysilane (CH₂=CHSiCH₃(OCH₃)₂), butyl melamine-based, isocyanate- based, metal chelate-based, and epoxy-based crosslinking agents.

13. The method of claim 9, wherein the polymerization initiator comprises a photoinitiator or a thermal initiator,
the photoinitiator comprises at least one selected from the group consisting of 2-hydroxy-2-methylpropiophenone (HMPP), 1-hydroxycyclohexyl phenyl ketone (HCPK), diphenyl (2,4,6-trimethylbenzoyl) phosphine oxide (TPO), phenylbis (2,4,6-trimethylbenzoyl) phosphine oxide (BAPO), or Type I photoinitiator and Type II photoinitiator, or a compound capable of generating radicals by light, and
the thermal initiator comprises at least one selected from the group consisting of azobisisobutyronitrile (AIBN), benzoyl peroxide (BPO), or a compound capable of generating radicals by heat.
